(19) United States
(12) Patent Application Publication
(10) Pub. No.: US 2009/0002910 A1
(43) Pub. Date: Jan. 1, 2009

(54) OVER VOLTAGE PROTECTION DEVICE WITH AN AIR-GAP

(75) Inventors: TE-PANG LIU, Miaoli (TW); SHENG-FU SU, Miaoli (TW); YI-LIN WU, Miaoli (TW)

Correspondence Address: WPAT, PC;INTELLECTUAL PROPERTY ATTORNEYS, 2030 MAIN STREET, SUITE 1300, IRVINE, CA, 92614, US

(73) Assignee: INPAQ TECHNOLOGY CO., LTD., Miaoli (TW)

(21) Appl. No.: 12/062,191

(22) Filed: Apr. 3, 2008

(30) Foreign Application Priority Data
Jun. 27, 2007 (TW) 096123173
Nov. 6, 2007 (TW) 096141888

(51) Int. Cl. H01C 7/12

(52) U.S. Cl. 361/119

(57) ABSTRACT

The present invention relates to an over voltage protection device with an air gap and a manufacturing method thereof. The over voltage protection device provides over voltage protection by using an air gap extending into a first substrate and a second substrate. The air gap is formed by a first trench of the first substrate and a second trench of the second substrate.

### BACKGROUND OF THE INVENTION

1. Field of the Invention

The present invention relates to an over voltage protection device. More particularly, the present invention relates to an over voltage protection device with an air gap and a manufacturing method thereof.

2. Description of the Prior Art

Over voltage protection devices have been widely used in various electronic products, for example, telephones, fax machines, and modems, etc., and especially in electronic communication devices, so as to prevent errors caused by damage from abnormal voltages or electro-static discharges (ESD).

In the industry, various over voltage protection devices, e.g., a transient voltage suppress diode (TVSD) device and multi-layer varistor (MLV), etc., have been developed. These devices enable the electronic products to withstand the over voltage by providing a design for protection circuitry. In addition, ROC Patent Publication No. 1253881 also provides a chip-type micro-air-gap discharging protection element and a manufacturing method thereof. The prior art uses a thick film printing process to form a hollow air chamber with a micro-gap between two main discharging electrodes, so as to provide the function of over voltage protection. However, the design of the over voltage protection still has the following disadvantages. In the process of thick film printing, each time a layer of material is printed, the material must be sintered in a sintering furnace, so the printing and the sintering processes are repeated. Thus, the process is time-consuming and a lot of operations are needed. Meanwhile, a thickness of the thick film printing layer is within a certain limit, so the depth of the air gap is limited.

### SUMMARY OF THE INVENTION

In view of the above, the present invention provides an over voltage protection device with an air gap and a manufacturing method thereof. The device and method are capable of eliminating the above disadvantages and satisfying the requirements of the industry.

The over voltage protection device according to a first embodiment of the present invention includes a first substrate; an electrode layer formed on the first substrate; a first trench cutting the electrode layer open and extending into the first substrate; a second substrate having a second trench located at a position corresponding to the first trench and having the same width and the same length as the first trench. The second substrate is disposed on the first substrate, so as to make the first trench and the second trench communicate with each other. The first trench and the second trench are used to form a air gap extending into the first substrate and the second substrate.

The air gap is used to provide the over voltage protection. The size of the air gap can be adjusted according to requirements and specifications. For example, the depth and the width of the air gap are not limited by the process.

Meanwhile, a lamination process is used, so as to omit the repeated printing and sintering processes in the thick film printing process. The manufacturing method of the present invention is simplified compared with the thick film printing process.

According to a feature of the present invention, if the electrode layer of the present invention is an internal electrode type, a tip of a discharging end has an advantage of tip discharging, so as to reduce a triggering voltage of the device.

Further features and functions of the present invention can be understood in detail with reference to the following embodiments and the description of the drawings.

### BRIEF DESCRIPTION OF THE DRAWINGS

FIGS. 1A and 1B are a top view and a cross-section view respectively of a first substrate formed according to a first embodiment of the present invention;

FIGS. 2A and 2B are a top view and a cross-section view respectively of an electrode layer formed according to the first embodiment of the present invention;

FIGS. 3A and 3B are a top view and a cross-section view respectively of a first trench formed according to the first embodiment of the present invention;

FIGS. 4A and 4B are a top view and a cross-section view respectively of a second substrate formed according to the first embodiment of the present invention;

FIG. 5 shows a structure of an over voltage protection device formed according to the first embodiment of the present invention;

FIG. 6 is a perspective view of the structure of the over voltage protection device formed according to the first embodiment of the present invention;

FIGS. 7A and 7B are a top view and a cross-section view respectively of a first substrate formed according to a second embodiment of the present invention;

FIGS. 8A and 8B are a top view and a cross-section view respectively of an electrode layer formed according to the second embodiment of the present invention;

FIGS. 9A and 9B are a top view and a cross-section view respectively of an insulating layer formed according to the second embodiment of the present invention;

FIGS. 10A and 10B are a top view and a cross-section view respectively of another electrode layer formed according to the second embodiment of the present invention;

FIGS. 11A and 11B are a top view and a cross-section view respectively of a first trench formed according to the second embodiment of the present invention;

FIGS. 12A and 12B are a top view and a cross-section view respectively of a second substrate formed according to the second embodiment of the present invention;

FIG. 13 shows a structure of an over voltage protection device formed according to the second embodiment of the present invention; and

FIG. 14 shows a structure of an over voltage protection device formed according to a third embodiment of the present invention;

FIGS. 15A and 15B are a top view and a cross-section view respectively of a first substrate formed according to a fourth embodiment of the present invention;

FIGS. 16A and 16B are a top view and a cross-section view respectively of an electrode layer formed according to the fourth embodiment of the present invention;

FIGS. 17A and 17B are a top view and a cross-section view respectively of a second substrate formed according to the fourth embodiment of the present invention;

FIGS. 18A and 18B are a top view and a cross section view respectively of a trench formed according to the fourth embodiment of the present invention;

FIG. 19A is a top view of a third substrate formed according to the fourth embodiment of the present invention;

FIG. 19B is a cross-section view of an over voltage protection device formed according to the fourth embodiment of the present invention;

FIGS. 20A and 20B are a top view and a cross-section view respectively of a first substrate formed according to a fifth embodiment of the present invention;

FIGS. 21A and 21B are a top view and a cross-section view respectively of an electrode layer formed according to the fifth embodiment of the present invention;

FIGS. 22A and 22B are a top view and a cross-section view respectively of a second substrate formed according to the fifth embodiment of the present invention;

FIG. 23 is a cross section view respectively of a trench formed according to the fifth embodiment of the present invention;

FIG. 24A is a top view of a third substrate formed according to the fifth embodiment of the present invention;

FIG. 24B is a cross-section view of an over voltage protection device formed according to the fifth embodiment of the present invention.

### DETAILED DESCRIPTION

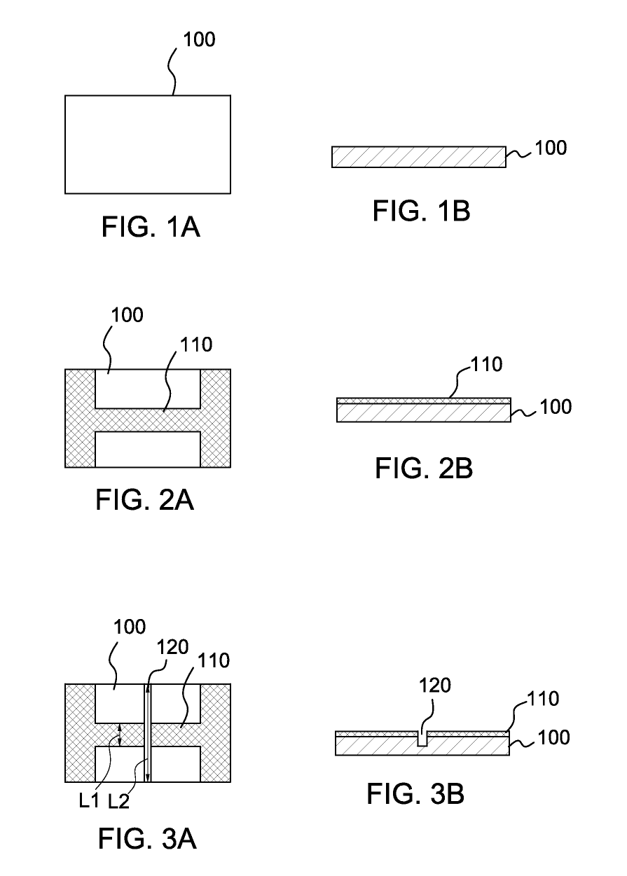

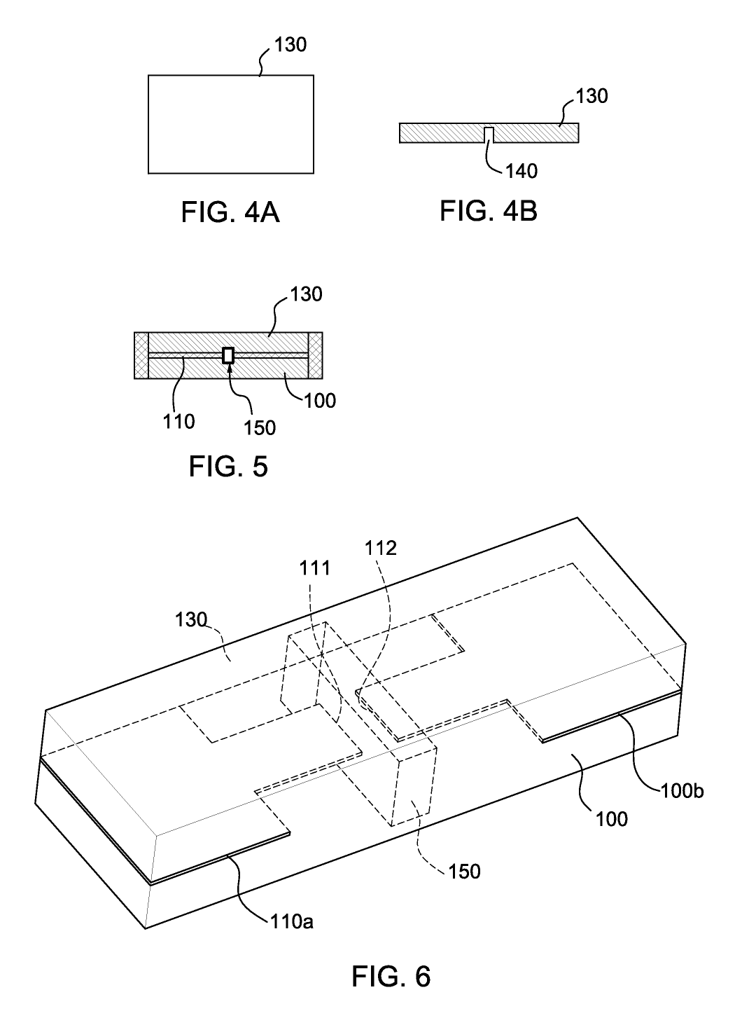

FIGS. 1A to 5 are schematic diagrams of the structure of an over voltage protection device formed according to a first embodiment of the present invention. Referring to FIGS. 1A to 5, a method of forming the over voltage protection device of the first embodiment includes the following steps. Firstly, a bottom substrate (100) is provided (referring to FIGS. 1A and 1B). Next, an electrode layer (110) is formed (referring to FIGS. 2A and 2B). A first trench (120) is formed, and the first trench (120) cuts the electrode layer (110) open and extends into the bottom substrate (100). The trench has a length L1, and the electrode has a width L2, and L2 is greater than L1 (referring to FIGS. 3A and 3B). A top substrate (130) having a second trench (140) is provided, and the second trench (140) is located at a position corresponding to the first trench (120) and has the same width and the same length L1 as the first trench (referring to FIGS. 4A and 4B). The top substrate (130) is formed on the bottom substrate (100), so that the first trench (120) and the second trench (140) communicate with each other, to form the over voltage protection device. The device uses the first trench (120) and the second trench (140) to form a hollow air gap (150) extending into the bottom substrate (100) and the top substrate (130). The air gap (150) is surrounded by the bottom substrate, the electrode layer, and the top substrate (referring to FIG. 5). The hollow air gap (150) is used to provide the over voltage protection, so as to prevent damages caused by an over voltage.

FIG. 6 is a perspective view of the first embodiment, which clearly shows the relations and the structure of each of the elements (100, 110, 130, 150) of the first embodiment, and helps persons to further understand the technical features of the present invention. The electrode layer (110) is divided into a left electrode layer (110a) and a right electrode layer (110b). The shapes of the neighboring ends (111, 112) of a left electrode layer (110a) and a right electrode layer (110b) are flat. In another embodiment, the neighboring ends can be tip shaped.

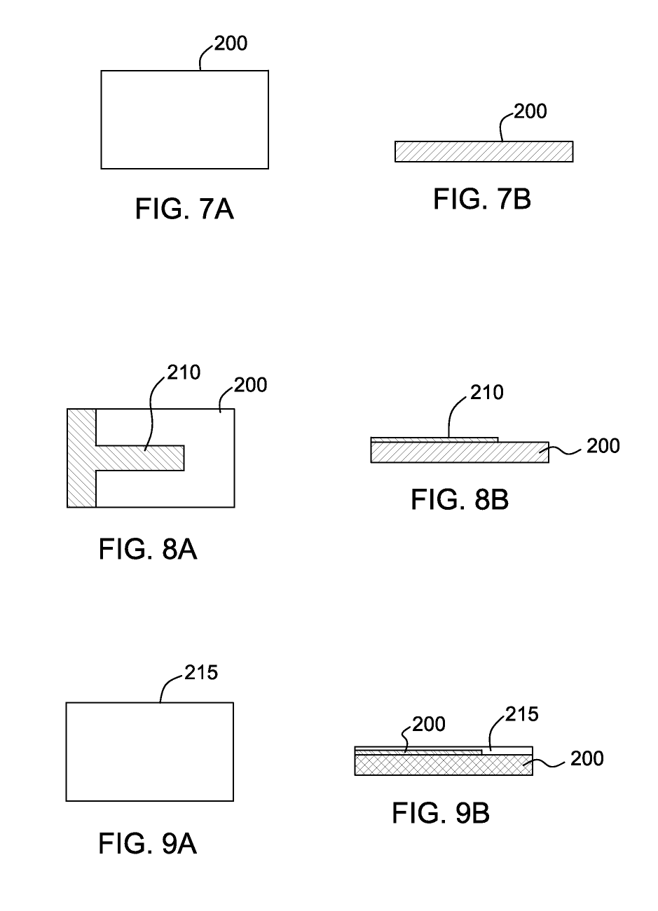

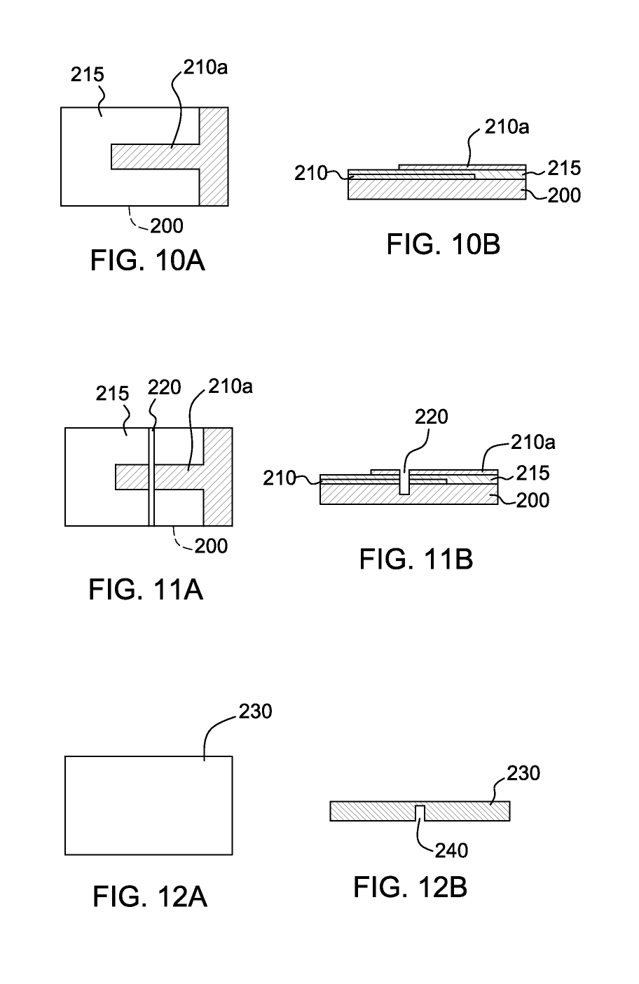

FIGS. 7A to 13 are schematic diagrams of the structure of an over voltage protection device formed according to a second embodiment of the present invention. Referring to FIGS. 7A to 13, the over voltage protection device of the second embodiment is a multi-layer structure, and a method of forming the multi-layer structure includes the following steps. First, a bottom substrate (200) is provided (referring to FIGS. 7A and 7B). An electrode layer (210) is formed (referring to FIGS. 8A and 8B). Next, an insulating layer (215) is formed on the electrode layer (210) (referring to FIGS. 9A and 9B). Another electrode layer (210a) is stacked on the insulating layer (215) (referring to FIGS. 10A and 10B). In a different embodiment, an over voltage protection device can comprise a plurality of electrode layers by the stacking step as described above, and insulating layers are formed between two electrode layers of the plurality of the electrode layers, so as to form a multi-layer structure.

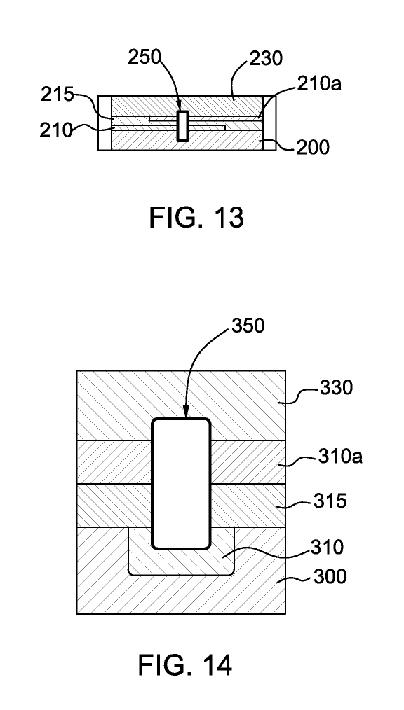

Then, a first trench (220) is formed, and the first trench (220) cuts the multi-layer structure open and extends into the bottom substrate (200) (referring to FIGS. 11A and 11B). A top substrate (230) having a second trench (240) is located at a position corresponding to the first trench (220) and has the same width and the same length as the first trench (referring to FIGS. 12A and 12B). Then, the top substrate (230) is disposed on the bottom substrate (200), so as to join the first trench (220) and the second trench (240). A hollow air gap (250) of the over voltage protection device of the second embodiment is formed by the first trench (220) and the second trench (240), which extends into the bottom substrate (200) and the top substrate (230), and is surrounded by the bottom substrate, the multi-layer structure, and the top substrate (referring to FIG. 13).

FIG. 14 is a sectional view of the structure of an over voltage protection device formed according to a third embodiment of the present invention. The structure and the manufacturing process of the over voltage protection device of the third embodiment are similar to those of the first two embodiments of the present invention, while a difference lies in the fact that a first electrode layer (310) and a hollow air gap (350) are disposed in parallel to the direction vertical to the paper. The first electrode layer (310) can be connected to the ground, and a second electrode layer (310a) can be a discharging electrode, for example, a data line, so as to form a feed-through over voltage protection device with the hollow air gap. That is, the second electrode layer (310a) can discharge electrical charges to the first electrode layer (310), so as to form the over voltage protection.

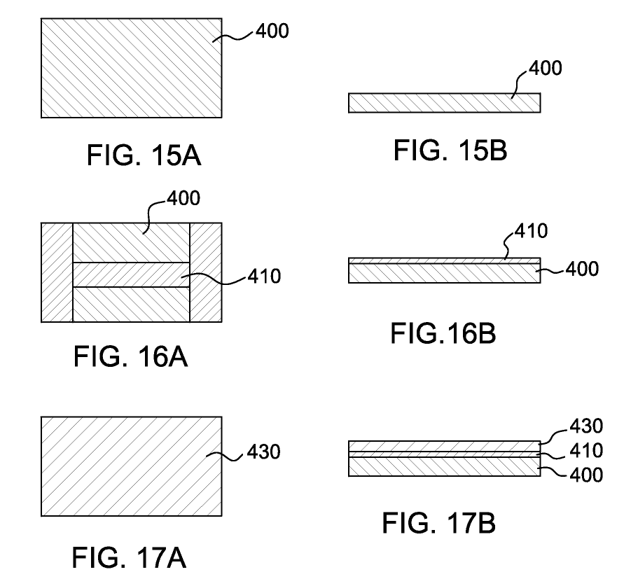

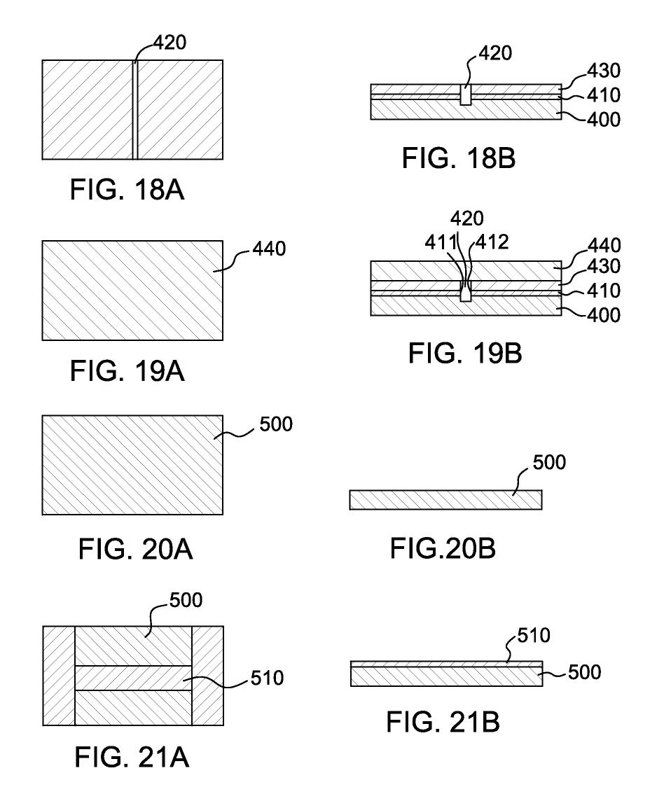

FIGS. 15A to 19B are schematic diagrams of the structure of an over voltage protection device formed according to a fourth embodiment of the present invention. Referring to FIGS. 15A to 19B, a method of forming an over voltage protection device of the fourth embodiment includes the following steps. Firstly, a first substrate (400) is provided (referring to FIGS. 15A and 15B). Next, an electrode layer (410) is formed on the first substrate (400) (referring to FIGS. 16A and 16B), wherein the electrode layer (410) can be I- or T-shape. A second substrate (430) is formed on the electrode layer (410) (referring to FIGS. 17A and 17B). A trench (420) is formed, and the trench (420) cuts the second substrate (430) and the electrode layer (410) open and extends into the first substrate (400) (referring to FIGS. 18A and 18B). The trench (420) has a length L2, and the electrode layer has a width L1, L2>L1. The trench (420) cuts the electrode layer (410) open to form a left electrode layer having a first end (411) and a right electrode layer having a second end (412), and the first end and the second end can be tip shaped. A third substrate (440) is provided (referring to FIG. 19A) to overlay the second substrate (430), so as to form the over voltage protection device (referring to FIG. 19B). The trench (420) is defined by the first substrate, the electrode layer, the second substrate and the third substrate, to provide the over voltage protection, so as to prevent damages caused by an over voltage.

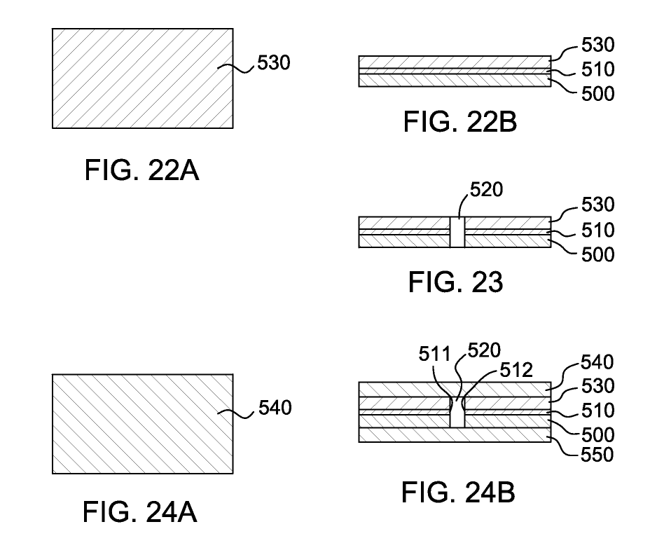

FIGS. 20A to 24B are schematic diagrams of the structure of an over voltage protection device formed according to a fifth embodiment of the present invention. Referring to FIGS. 20A to 24B, a method of forming the over voltage protection device of the fifth embodiment includes the following steps. Firstly, a first substrate (500) is provided (referring to FIGS. 20A and 20B). Next, an electrode layer (510) is formed on the first substrate (500) (referring to FIGS. 21A and 21B), wherein the electrode layer (510) can be I- or T-shape. A second substrate (530) is formed on the electrode layer (510) (referring to FIGS. 22A and 22B). A trench (520) is formed, and the trench (520) cuts the first substrate (500), the second substrate (530) and the electrode layer (510) open (referring to FIG. 23). The trench (520) has a length L2, and the electrode layer has a width L1, L2>L1. The trench (520) cuts the electrode layer (510) open to form a left electrode layer having a first end (511) and a right electrode layer having a second end (512), and the first end and the second end can be tip shaped. A third substrate (540) (referring to FIG. 24A) is provided to overlay the second substrate (430), and a fourth substrate (550) (not shown) is disposed under the first substrate (500), so as to form the over voltage protection device (referring to FIG. 24B). The trench (520) is defined by the first substrate, the electrode layer, the second substrate, the third substrate and the fourth substrate, to provide the over voltage protection, so as to prevent damages caused by an over voltage.

The electrode layers of the present invention can be made of one of the following metals: gold, silver, palladium, platinum, tungsten, copper and an alloy of any combination of the metals, and a mixed material including any combination of the metals. The electrode layers can be I-shaped or T-shaped. Meanwhile, the first trench is used to cut the electrode layers open to form a first end and a second end, and the first end and the second end can be tip shaped and thus have the function of point discharging. In addition, a nano-tube can be introduced into the electrode layers, so as to reduce a triggering voltage. The nano-tube can be a carbon nano-tube, an aluminum nano-tube, or a mixture of the carbon nano-tube and aluminum nano-tube. At the same time, the top substrate and the bottom substrate of the present invention are formed by an insulating material and can be a multi-layer thin film. The insulating material can include aluminum, for example, Al₂O₃, titanium, or silicon.

It will be apparent to those skilled in the art that various modifications and variations can be made to the structure of the present invention without departing from the scope or spirit of the invention. In view of the foregoing, it is intended that the present invention cover modifications and variations of this invention, provided that they fall within the scope of the following claims and their equivalents.

What is claimed is:

1. An over voltage protection device, comprising:
a first substrate having a first trench having a width and a length;
an electrode layer disposed on the first substrate, wherein the first trench cuts the electrode layer open and extends into the first substrate;
a second substrate having a second trench located at a position corresponding to the first trench and having the same width and the same length as the first trench, and disposed on the first substrate, so as to join the first trench and the second trench.

2. The over voltage protection device as claimed in claim 1, wherein the electrode layer is made of one of the following metals: gold, silver, palladium, platinum, tungsten and copper, an alloy of any combination of the metals, and a mixed material comprising any combination of the metals.

3. The over voltage protection device as claimed in claim 1, wherein a nano-tube is introduced into the electrode layer, so as to reduce a triggering voltage.

4. The over voltage protection device as claimed in claim 3, wherein the nano-tube is a carbon nano-tube or an aluminum nano-tube, and a mixture of the carbon nano-tube and the aluminum nano-tube.

5. The over voltage protection device as claimed in claim 1, wherein the first substrate and the second substrate are made of an insulating material.

6. The over voltage protection device as claimed in claim 5, wherein the insulating material comprises at least one of aluminum, titanium and silicon.

7. The over voltage protection device as claimed in claim 1, wherein the electrode layer is I-shaped or T-shaped.

8. The over voltage protection device as claimed in claim 1, wherein the first trench has a length L2, and the electrode layer has a width L1, and L2>L1.

9. The over voltage protection device as claimed in claim 1, wherein the first trench cuts the electrode layer open to form a left electrode layer having a first end and a right electrode layer having a second end, and the first end and the second end are tip shaped.

10. A method of manufacturing an over voltage protection device, comprising:
providing a first substrate;
forming an electrode layer on the first substrate;
forming a first trench having a length and width, cutting the electrode layer open and extending into the first substrate;
providing a top substrate having a second trench located at a position corresponding to the first trench and having the same width and the same length as the first trench; and disposing the top substrate on the first substrate, so as to join the first trench and the second trench.

11. The method as claimed in claim 10, further comprising forming the electrode layer with one of the following metals: gold, silver, palladium, platinum, tungsten and copper, an alloy of any combination of the metals, and a mixed material comprising any combination of the metals.

12. The method as claimed in claim 10, further comprising using a nano-tube to form the electrode layer to reduce a triggering voltage.

13. The method as claimed in claim 12, wherein the nano-tube is formed by a carbon nano-tube or an aluminum nano-tube, and a mixture comprising the carbon nano-tube and the aluminum nano-tube.

14. The method as claimed in claim 10, further comprising forming the first substrate and the second substrate with an insulating material.

15. The method as claimed in claim 14, wherein the insulating material is aluminum, titanium, or silicon.

16. The method as claimed in claim 10, wherein the first trench has a length L2, and the electrode has a width L1, and L2>L1.

17. The method as claimed in claim 10, wherein the first trench divides the electrode layer to form a left electrode layer having a first end and a right electrode layer having a second end, and the first end and the second end are tip shaped.

18. An over voltage protection device, comprising:
a first substrate having a first trench;
a multi-layer structure, disposed on the first substrate by way of stacking, wherein the multi-layer structure comprises at least two electrode layers, an insulating layer is disposed between every two electrode layers, and the first trench cuts the multi-layer structure open and extends into the first substrate;
a second substrate having a second trench located at a position corresponding to the first trench, wherein the second trench has the same width and the same length as the first trench, and the second substrate is disposed on the first substrate, so as to join the first trench and the second trench.

19. The over voltage protection device as claimed in claim 18, wherein at least two electrode layers are made of one of the following metals: gold, silver, palladium, platinum, tungsten and copper, an alloy of any combination of the metals, and a mixed material comprising any combination of the metals.

20. The over voltage protection device as claimed in claim 18, wherein a nano-tube is added between the at least two electrode layers, so as to reduce a triggering voltage.

21. The over voltage protection device as claimed in claim 20, wherein the nano-tube is a carbon nano-tube or an aluminum nano-tube, and a mixture comprising the carbon nano-tube and an aluminum nano-tube.

22. The over voltage protection device as claimed in claim 18, wherein the first substrate and the second substrate are made of an insulating material.

23. The over voltage protection device as claimed in claim 22, wherein the insulating material comprises at least one of aluminum, titanium and silicon.

24. The over voltage protection device as claimed in claim 18, wherein the first trench has a length L2, and at least two electrode layers have a width L1, and L2>L1.

25. The over voltage protection device as claimed in claim 18, wherein the first trench divides at least two electrode layers to form a left electrode layer having a first end and a right electrode layer having a second end, and the first end and the second end are tip shaped.
